(19) United States
(12) Patent Application Publication
(10) Pub. No.: US 2026/0295406 A1
(43) Pub. Date: Oct. 1, 2026

(54) ENHANCING BLOCKOUTS OF VIRTUAL INTERACTIVE ENVIRONMENT FOR VIDEO GAMES

(71) Applicant: Electronic Arts Inc., Redwood City, CA (US)

(72) Inventors: Hau Nghiep Phan, Montreal (CA); Mohamed Hassan, Fairfax, VA (US); Hector Anadon Leon, Cartagena (ES); Han Liu, Millbrae, CA (US); Raymond Phan, Mississauga (CA)

(21) Appl. No.: 19/095,760

(22) Filed: Mar. 31, 2025

(51) Int. Cl. A63F 13/52; G06T 5/50; G06T 5/77; G06T 15/04; G06T 17/10; G06T 17/20

(52) U.S. Cl. CPC A63F 13/52; G06T 5/50; G06T 5/77; G06T 15/04; G06T 17/10; G06T 17/20; G06T 2207/10016; G06T 2210/21; G06T 2210/36

(57) ABSTRACT

A system and method for improving the graphical quality of a virtual interactive environment by applying enhancements to various environmental assets is provided. The system enhances skyboxes, terrains, and blockout structures by generating and applying detail assets that enhance visual and physical characteristics. Additionally, a virtual camera records a first video of the enhanced environmental assets. The first video is processed to generate a second video that depicts the enhanced environmental assets with improved visual fidelity. The second video is analyzed to further refine the enhanced environmental assets based on how they appear across multiple frames in the second video.

### INCORPORATION BY REFERENCE TO ANY PRIORITY APPLICATIONS

Any applications to which a foreign or domestic priority claim is made in the Application Data Sheet of this disclosure is hereby incorporated by reference under 37 CFR 1.57.

### BACKGROUND

Creating high-fidelity virtual interactive environments in video game development is time-intensive, requiring manual asset creation, placement, and refinement. Traditional workflows rely on manual modeling and texturing techniques, often leading to long iteration cycles. Accordingly, there is a need for an efficient improvement when transitioning a video game from prototyping to production quality.

### SUMMARY

The present disclosure provides for systems, methods, and non-transitory computer readable mediums for improving the visual and/or graphical fidelity of video games by accessing a virtual interactive environment; and enhancing graphical fidelity properties of environmental assets among the virtual interactive environment that correspond to at least the following: (a) a skybox of the virtual interactive environment, wherein enhancing the skybox comprises at least applying a skybox texture to the skybox, and wherein the skybox texture is generated based at least in part on a first enhancement instruction that defines a visual aesthetic for the skybox; (b) a terrain of the virtual interactive environment, wherein enhancing the terrain comprises at least applying a terrain texture to the terrain, and wherein the terrain texture is generated based at least in part on a second enhancement instruction that defines a visual aesthetic for the terrain; and (c) a blockout structure of the virtual interactive environment, wherein to enhance the blockout structure further comprises: (i) gathering render data corresponding to the blockout structure, the render data comprising at least a plurality of view images associated with the blockout structure and depth data corresponding to each view image among the plurality; (ii) generating a structure texture based at least in part on the gathered render data and a third enhancement instruction that defines a visual aesthetic for the blockout structure; (iii) generating a normal map comprising surface normals based at least in part on the structure texture; (iv) generating a collision mesh based at least in part on the normal map and the blockout structure; and (v) applying the structure texture, normal map, and collision mesh to the blockout structure to create an enhanced blockout structure.

Additionally, further improvements can be made to video games by receiving at least: (i) a virtual camera path associated with the virtual camera comprising a set of positional points the virtual camera used to move through the virtual interactive environment to capture the first video; and (ii) positional points of each of the enhanced blockout structures captured among the first video; estimating positional points of each refined structure included in the second video, wherein the estimation is based at least in part on the set of positional points of the virtual camera path and the positional points of the enhanced structures; associating each of the refined structures to each of the enhanced blockout structures, wherein the association is based at least in part on the estimated positional points of refined structures and the positional points of the enhanced structures; refining each of the enhanced blockout structures associated by: generating a gaussian representation of a refined structure based at least in part on one or more frames of the second video; and performing vertex displacement and uniform mesh subdivision to the collision mesh of an enhanced blockout structure based on the gaussian representation.

### BRIEF DESCRIPTION OF THE DRAWINGS

This disclosure will be more fully understood from the following detailed description taken in conjunction with the accompanying drawings, in which:

FIG. 1 is a system diagram of a hardware environment according to an example embodiment;

FIG. 2 is a system diagram of a software environment according to an example embodiment;

FIG. 3 illustrates a flowchart of a process for procedurally enhancing a virtual interactive environment using a blockout module, according to an example embodiment;

FIG. 4 illustrates a flowchart of a process for refining an enhanced virtual interactive environment using a blockout module, according to an example embodiment;

FIG. 5 illustrates an example embodiment of an environmental asset within a virtual interactive environment, according to an example embodiment;

FIG. 6 illustrates an example embodiment of an enhanced environmental asset within a virtual interactive environment, according to an example embodiment;

FIG. 7 illustrates an example embodiment of an enhanced environmental asset within a virtual interactive environment, according to an example embodiment; and

FIG. 8 is a diagram of an example computing device usable to perform any of the methods described herein.

### DETAILED DESCRIPTION

The systems and methods described herein provide for enhancing blockouts of virtual interactive environments corresponding to a video game and/or virtual social space.

In particular, the disclosed systems and methods introduce an automated pipeline that dynamically enhances environmental assets such as skyboxes, terrain, and blockout structures. A blockout module processes enhancement instructions to generate high-resolution textures, apply mesh subdivision techniques, and refine surface details using normal map-based vertex displacement and collision mesh adjustments. The disclosed methods enable automated, real-time enhancement workflows, reducing manual intervention while maintaining artistic control.

Additionally, the system introduces a hybrid enhancement workflow, allowing game assets to be refined through either procedural enhancement methods, video-based refinement, or a combination of both. The system dynamically determines whether to apply deterministic texture generation, physics-informed mesh subdivision, or Gaussian-based upscaling, depending on the available data and enhancement parameters. By incorporating adaptive procedural texture synthesis, real-time material inference, and automated collision mesh refinement, this technology provides a scalable, efficient solution for improving game assets with minimal developer intervention.

A distinguishing feature of this system is its ability to generate a video-based refinement process for providing further and/or iterative enhancements to a virtual interactive environment of a video game (e.g., a video game level). In some embodiments, the system captures a video within the virtual interactive environment after an initial enhancement pass, which is then processed to generate a second video that depicts further improved structural and visual fidelity. This second video serves as a multi-frame data source for processing further refinements, such as Gaussian-based reconstruction techniques.

As used herein, the terms “refinement” and “refine” are similar to “enhancement” and “enhance” and may be used interchangeably to describe improvements to aspects of a video game.

As used herein, a “blockout level” is a preliminary version of a virtual interactive environment used during the early stages of game development. As known to a person of ordinary skill in the art, it is composed of simplified geometric representations of terrain, structures, and interactive elements without finalized textures, materials, or fine details. Blockout levels are primarily used for level design, spatial layout testing, and gameplay mechanics validation, ensuring that player navigation, sightlines, and level flow function correctly before detailed assets are added. These levels can be manually created by developers or generated procedurally within a game development environment.

Accordingly, a “blockout structure” is a foundational architectural or environmental element within a blockout level. As known to a person of ordinary skill in the art, it is typically formed from basic geometric shapes, such as cubes, cylinders, and planes, to represent buildings, bridges, staircases, or other structural elements. Blockout structures define the physical and spatial composition of structures within a game level before undergoing refinement processes, including mesh subdivision, texture application, and procedural enhancements. These structures serve as placeholders for finalized game assets, allowing for iterative improvements through procedural and AI-driven refinement techniques.

Additionally, a “blockout shape” refers to an individual geometric component used to construct a blockout structure. As known to a person of ordinary skill in the art, these shapes include basic primitives such as cubes, spheres, pyramids, and planes, which can be combined or modified to define the form of environmental assets. Blockout shapes determine the initial topology and volume of game assets and can be adjusted, subdivided, or deformed during the refinement process. In some embodiments, blockout shapes are used as input data for procedural generation techniques, allowing for automatic transformation into high-detail game assets through texture synthesis and mesh upscaling.

As known to a person of ordinary skill in the art, these “blockouts” (e.g., blockout shapes and blockout structures) can include a “mesh” or “collision mesh.” A collision mesh is a simplified geometric representation of a blockout shape or blockout structure used for collision detection and physics interactions within a virtual interactive environment. Unlike visual meshes, which define the graphical appearance of an asset, collision meshes are optimized for real-time processing and are used by the game engine to determine how objects interact physically. In the context of blockout shapes and blockout structures, a collision mesh serves as an approximation of the object’s physical boundaries, ensuring that virtual characters, entities, and other in-game objects respond correctly to environmental collisions. In some embodiments, a visual mesh of a blockout shape defines and/or produces a corresponding collision mesh. Alternatively, collision meshes can be procedurally, deterministically, and/or manually created.

As used herein, an “environmental asset” refers to any graphical, structural, or interactive element within a virtual interactive environment that contributes to the composition, aesthetics, and functionality of a game level or digital scene. Environmental assets can include, but are not limited to, buildings, terrain, skyboxes, vegetation, bodies of water, roads, infrastructure, lighting, atmospheric effects, and interactive objects. These assets define the visual style, navigable areas, and interactive components of a virtual world.

In some embodiments, environmental assets can exist within the interactive playable space of a video game level, where they are configured for direct player interaction, traversal, or in-game physics simulations. These assets may include walkable terrain, destructible objects, doors, climbable structures, and other interactive game elements. Environmental assets can also exist beyond the playable space, where they serve as non-interactive background elements designed to enhance visual immersion while remaining inaccessible to players during gameplay. These assets may include distant landscapes, unreachable buildings, decorative skybox elements, and other visual set pieces that contribute to the overall aesthetic and spatial depth of the virtual interactive environment.

Environmental assets are often mocked and/or prototyped using blockouts within a blockout level to provide a framework for level design, player navigation testing, and iterative adjustments to spatial layout and gameplay flow. As described herein, blockout assets and/or environmental assets can be processed, enhanced, or replaced using procedural texture synthesis, mesh upscaling, and video-based reconstruction techniques, allowing prototype game levels to evolve into fully detailed environmental assets.

### System Overview

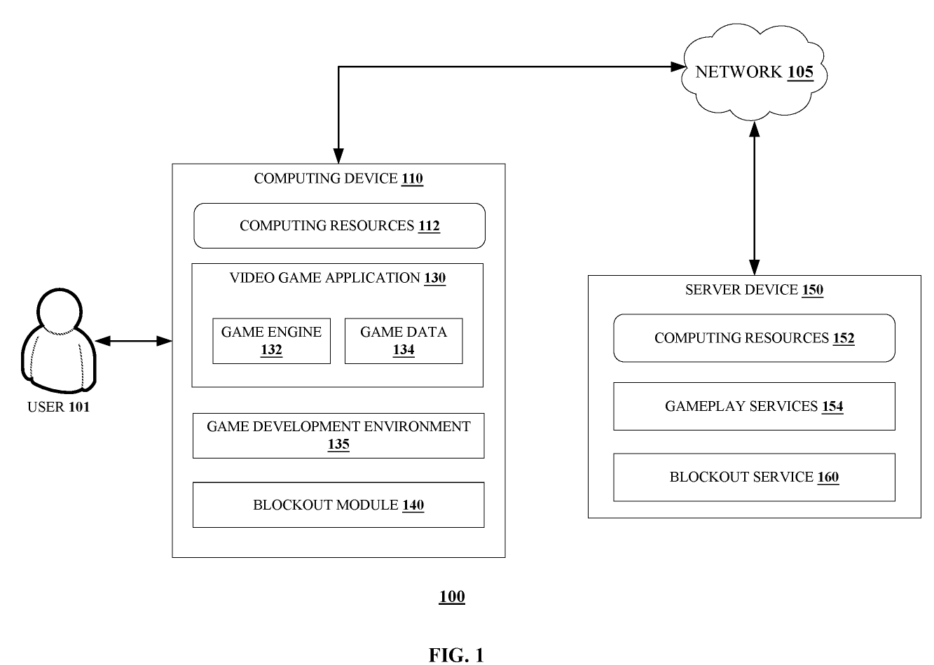

FIG. 1 is a system diagram of a development environment 100 according to an example embodiment. Development environment 100 illustrates a system architecture of software and hardware for developing, testing, and refining a video game application (or “video game” in short), including computing device 110, server device 150, and network 105. In some embodiments, the system enables enhancements and/or refinements of game assets – including blockouts – through computing processes and resources among computing device 110 and/or server device 150.

As shown in FIG. 1, development environment 100 includes computing device 110 that is associated with - or operated and/or controlled by - user 101. As known to those of skill in the art, users can operate or control a computing device through inputs provided via input devices of, or associated with, the computing device. For instance, user 101 can provide inputs to computing device 110 through one or more input devices (e.g., controller, keyboard, mouse, touchscreen, camera, microphone, etc.). Additionally, computing device 110 can output, communicate, and/or provide information (e.g., display, render, play audio) to users through one or more output devices (e.g., monitor, screen, touchscreen, speaker, haptics, etc.) of, or associated with, the computing device.

User 101 can be a player, spectator, and/or an automated agent (hereinafter “agent” in short). The term “player” corresponds to a user of a video game application, whereas a “spectator” can correspond to a user of a spectating application. As known to a person of ordinary skill in the art, an “agent” can include a machine learning model and/or software to automate or perform one or more tasks (e.g., playing or testing a video game). For instance, agents can function as users and be deployed, controlled, and/or directed by a computing device to perform and/or automate one or more tasks through common techniques known to those of skill in the art.

Computing device 110 can be or include any one or a combination of systems known to those of skill in the art, including, for example, a desktop, laptop, game application platform, game console, virtual reality system, augmented reality system, television set-top box, television, network-enabled kiosk, car-console devices, computerized appliance, wearable device (e.g., smart watch, glasses with computing functionality), and wireless mobile devices (e.g., smart phones, PDAs, tablets). Computing device 110 can store and/or execute computer executable instructions (or code) of applications (or programs or software), such as video game applications, spectating applications, and/or other interactive applications known to those of skill in the art that could include or benefit from the systems and methods described herein.

Computing resources 112 of computing device 110 include hardware and software that are configured to execute a video game application and game development environment, among other types of applications. For example, computing resources 112 can include central processing units (CPUs), memory, mass storage, graphics processing units (GPUs), communication or networking components, input devices and/or output devices (I/O devices). In some embodiments, computing device 110 can include any number and/or combination of computing resources – including those described herein and others known to those of skill in the art – that are configured to perform the systems and methods described herein.

Video game application 130 of computing device 110 includes data and software that comprise a video game. Video game application 130 provides gameplay and other interactive and/or social features to users (or “players”) during runtime execution. For example, executing video game application 130 can cause an instance of the video game to be generated. Each instance can be referred to as a “game session” or “gameplay session”. The game session can be made up of or include one or more virtual interactive environments. A virtual interactive environment can be or include one or more virtual levels, virtual social spaces, and/or graphical user interfaces that can be interacted with or in, for gameplay or socializing. As such, a game session can include, host, or enable – for users – participation and interaction by or with player characters, non-player characters, quests, objectives, and other features, elements, assets, objects, or other in-game entities of the like as known to those of ordinary skill in the art.

By way of example and not limitation, video game application 130 includes game data 134 and game engine 132. As known to a person of ordinary skill in the art, a game engine uses game data (e.g., state data, render data, simulation data, audio data, and other data types of the like) to generate game sessions and/or render one or more outputs (e.g., visual output, audio output, and haptic output) corresponding to gameplay to one or more computing devices. Game data 134 includes state data, simulation data, rendering data, audio data, animation data, and other data of the like - including game code - used and/or produced by or among game engine 132 during execution of video game application 130 to generate game sessions and render the corresponding gameplay to a player, thereby allowing and/or enabling players to interact and/or engage with one or more aspects of the video game. In some embodiments, video game application 130 can be a video game that is in development. Accordingly, video game application 130 may include one or more prototyped aspects, including blockout levels (e.g., game levels in early design).

Blockout module 140 is software configured to process and/or enhance game assets of video game application 130. For example, blockout module 140 can enhance environmental assets of a video game by generating and/or enhancing textures and collision meshes to improve visual fidelity, and/or physical or functional characteristics. As used herein, enhancing graphical fidelity refers to the visual, physical, and/or other functional changes or improvements to a game asset, in whole or in part.

In some embodiments, blockout module 140 enhances game assets using a structured pipeline that includes techniques such as mesh subdivision, texture generation, normal map generation, vertex displacement, Gaussian splatting, video generation, and/or image analysis. These processes work together to improve the visual fidelity of a video game level (e.g., a virtual interactive environment). As shown in FIG. 1, blockout module 140 is an external component that interfaces with game development environment 135. In alternate embodiments, blockout module 140 is integrated within game development environment 135 as a processing module.

Network 105 includes any method of private and/or public connectivity, networking, and/or communication between or among hardware devices known in the arts. The network may be or include direct wired connections, Near Field Communication (NFC), a Local Area Network (LAN), a Virtual Private Network (VPN), an internet connection, or other communication methods known to those of skill in the art. As illustrated, network 105 communicatively couples computing device 110 to server device 150.

Server device 150 is a computing device including computing resources 152, which can be similar to the computing device 110 and computing resources 112. Server device 150 provides services to game development environment 135 and/or video game applications 130. As is known to a person of ordinary skill in the art, services (e.g., service applications) are software that provide functionality and/or data to other software applications. Services can be provided remotely over a network (commonly known as a “software as a service” or “SaaS” in short) or locally among a system.

The server device 150 can include gameplay services 154 corresponding to one or more aspects or features of a video game application, including matchmaking services, communication services, game state management, data storage, anti-fraud detection, and other game related services of the like. Server device 150 can be used to configure, develop, establish, test, execute, and maintain gameplay services 154 that correspond to video game application 130 in development among game development environment 135. Accordingly, gameplay services 154 can be used to facilitate gameplay parties, player communications, multiplayer gameplay and other interactions corresponding to a video game application.

Additionally, gameplay services 154 can include a user platform corresponding to game development environment 135. User accounts of the user platform can include data provided by users, such as a username, which identifies a user among game development environments. The user platform enables a user account to access and/or manage software and/or services corresponding to development environment 100 for development and/or gameplay, such as for multiplayer gameplay and/or content creation services, such as blockout service 160.

Blockout service 160 is a service to process and/or enhance game assets of video game application 130. In some embodiments, blockout service 160 is the same, or similar to blockout module 140. Accordingly, blockout service 160 can receive requests to enhance game assets – such as from game development environment 135 or blockout module 140.

In some embodiments, blockout service 160 can enhance game assets using techniques such as mesh subdivision, texture generation, normal map generation, vertex displacement, Gaussian splatting, video generation, and/or image analysis. As such, game development environment 135 works in conjunction with blockout module 140 and/or blockout service 160 to enable automated workflows for refining game assets within a virtual interactive environment, such as to provide distributed, remote, and/or parallel computing support.

In some embodiments, a user of game development environment 135 can configure which generative and/or procedural tasks are completed by a blockout module 140 and which are completed by a blockout service. For example, one configuration can specify that texture generation be handled locally by blockout module 140, while Gaussian-based refinements of collision mesh be processed remotely by blockout service 160. The configuration of task management for blockout module 140 and 160 may be based in part on game engine compatibility, available processing power, and/or user preferences, allowing developers to optimize enhancement workflows as needed.

### Blockout enhancement System

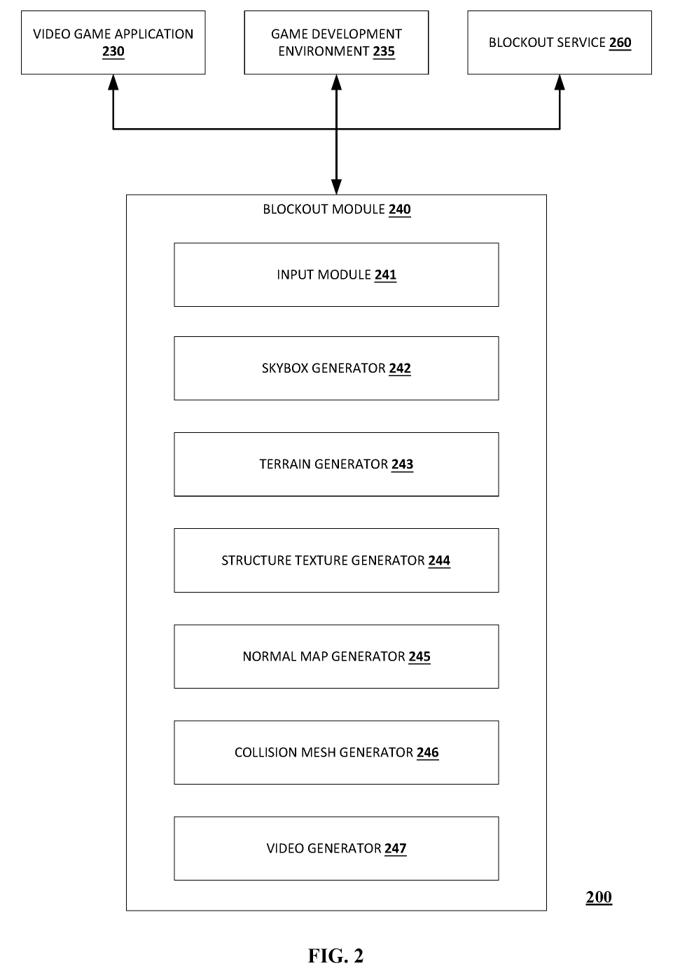

FIG. 2 is a system diagram of a software environment according to an example embodiment. Software environment 200 illustrates a system architecture for developing, testing, and enhancing a video game application, including video game application 230, game development environment 235, blockout module 240, and blockout service 260.

Video game application 230 of computing device 110 may include data and software that comprise a video game. Accordingly, video game application 230 provides gameplay and other interactive and/or social features to users during gameplay (e.g., during runtime execution). In some embodiments, video game application 230 is similar to video game application 130 described in FIG. 1.

Game development environment 235 may be software configured to facilitate the development and testing of a video game. This environment includes various tools and resources that enable developers to develop and test assets, levels, and gameplay mechanics efficiently. In some embodiments, game development environment 235 is similar to game development environment 135 described in FIG. 1.

Blockout module 240 may be software configured for enhancing game assets of video game application 230. Blockout module 240 can be an internal module of game development environment 235, such that the features of blockout module 240 can be accessed and/or processed among video game application 230. Alternatively, blockout module 240 can be standalone software that is used in conjunction with game development environment 235 and/or video game application 230. In some embodiments, blockout module 240 is similar to blockout module 140 of FIG. 1.

In some embodiments, blockout module 240 may include submodules (e.g., some or all of input module 241, skybox generator 242, terrain generator 243, structure texture generator 244, normal map generator 245, collision mesh generator 246, and/or video generator 247) that compose a pipeline and/or workflow that can be used to enhance one or more virtual interactive environments of video game application 230. In some embodiments, when processing one or more assets for one or more enhancements (e.g., an enhancement task), fewer submodules of blockout module 240 may be needed to complete the task.

Each submodule of blockout module 240 may include deterministic logic and/or one or more machine learning models that are configured and/or trained for performing one or more enhancement aspects and/or processes, including, but not limited to, analyzing one or more inputs to generate images, video, textures, and meshes. In some embodiment, each submodule of blockout module 240 includes its own pipeline and/or workflow for performing its corresponding enhancement task or enhancement process.

In some embodiments, input module 241 may be configured to receive data from a game development environment 235, video game application 230, and/or blockout service 260. In some embodiments, input module 241 is configured to access, retrieve, and/or receive game data corresponding to one or more aspects of video game application 230, such as levels, skyboxes, characters, structures, meshes, terrains, textures, cameras, and/or other virtual objects, assets, or entities of the like.

Additionally, input module 241 can also be configured to access, retrieve, and/or receive one or more enhancement instructions that correspond to the enhancement of one or more game assets of a virtual interactive environment of video game application 230. In some embodiments, enhancement instructions can include text data and/or labels that describe and/or define visual or aesthetic features or characteristics to enhance and/or alter one or more game assets by.

Accordingly, one or more enhancement instructions can be analyzed and decomposed into structured parameters or inputs, which are then mapped to specific enhancement processes or techniques for the activation of one or more submodules of blockout module 240. The mapping of enhancement instructions can be performed by deterministic logic and/or natural language processing. For example, an enhancement instruction can include the following text: “recreate the game level to a broken brick building in an abandoned town during the day,” which input module 241 can analyze and/or interpret to send inputs to one or more submodules of blockout module 240 to guide one or more corresponding enhancement processes for creating and/or enhancing the virtual interactive environment as instructed or detailed within the enhancement instructions.

In some embodiments, input module 241 includes one or more natural language processing models, such as transformer-based models, recurrent neural networks, or long short-term memory networks, which analyze enhancement instructions – or other text data input of the like – to extract parameters corresponding to environmental refinements. During training, these models are trained on labeled datasets associating textual descriptions with graphical asset modifications, allowing them to accurately interpret enhancement instructions and/or enhancement requests. During inference, input module 241 applies natural language processing techniques to categorize and map enhancement instructions as one or more inputs and/or instructions to one or more submodules of blockout module 240: skybox generator 242, terrain generator 243, structure texture generator 244, normal map generator 245, collision mesh generator 246, and video generator 247.

Alternatively, input module 241 can include deterministic logic that is configured to associate one or more words, terms, and/or phrases among enhancement instructions to one or more predefined labels, tags, categories, or other parameterized sets of the like, which can in turn be used as inputs and/or instructions to one or more submodules of blockout module 240.

In some embodiments, skybox generator 242 may be configured to generate skybox textures. As is known to a person of ordinary skill in the art, skybox textures are panoramic images that are applied to skybox assets to simulate, at least in part, a broader surrounding or atmosphere in a virtual interactive environment. For example, a skybox texture can be a high-resolution image of the sky that is applied to a virtual interactive environment, such that, when viewed from a perspective in the virtual interactive environment, simulates a detailed sky.

In some embodiments, skybox generator 242 generates and refines skybox textures by applying machine learning-based texture synthesis techniques. In some embodiments, generative adversarial networks, diffusion models, and convolutional neural networks are used to generate high-resolution panoramic skybox textures. Training data for these models includes large-scale datasets of sky textures, atmospheric effects, and environmental lighting conditions. Inference involves processing an enhancement instruction specifying a desired atmospheric condition and generating a synthetic skybox texture that seamlessly integrates with the rest of the environment. The output skybox texture is then updated within the virtual interactive environment.

In some embodiments, skybox texture generation involves generating panoramic sky textures using one or more procedural image synthesis methods. For example, rule-based fractal noise functions can be used to generate high-resolution sky features, while procedural texture synthesis (e.g., GANs trained on atmospheric datasets) can be used to refine cloud structures and lighting effects.

Similarly, terrain generator 243 may be configured with generating textures for terrains. As known to a person of ordinary skill in the art, a terrain in a virtual interactive environment refers to landscape features including mountains, valleys, and other geographical elements in a virtual environment. Terrains can be small or large, and video game levels often include a collection of terrains of various sizes, shapes, and features, to compose a video game level, such as, for example, mountains, roads, sidewalks, and trails.

In some embodiments, terrain generator 243 applies machine learning techniques to generate realistic terrain textures and elevation maps. In some embodiments, conditional generative adversarial networks, self-organizing maps, and heightmap prediction networks are used to create blended terrain textures with materials such as rock, sand, grass, and soil. The training data includes topographical maps, geological terrain textures, and high-resolution landscape imagery. During inference, terrain generator 243 may interpret enhancement instructions specifying terrain modifications and generates a corresponding terrain texture using generative adversarial network-based synthesis techniques.

In some embodiments, terrain texture generation can be based in part on normal-map or height-map procedural blending, where a mapping analyzes geological features to blend rock, soil, and vegetation textures in contextually appropriate ways. For example, when available among the game data of a virtual interactive environment, the terrain texture generator can use normal-map and/or height-map as input for generating terrain textures.

In some embodiments, structure texture generator 244 may be configured to create textures applied to structures in a video game. For example, structure textures are images that depict detailed surfaces and/or materials for environmental structures, such as buildings, tunnels, bridges, fences, walls, and other environmental assets of the like. In some embodiments, the structure texture generator 244 generates more than one texture to apply to a structure. For instance, a building may have different textures for the roof, exterior walls, interior walls, and flooring, among other things

In some embodiments, structure texture generator 244 creates and refines textures applied to buildings, bridges, walls, and other structural elements. In some embodiments, style transfer networks, super-resolution networks, and procedural convolutional neural networks are used to synthesize and enhance textures. The training process includes datasets of building materials, aged surfaces, and architectural textures, enabling the model to predict and apply realistic material textures based on contextual cues from surrounding assets. During inference, structure texture generator 244 modifies an existing texture or generates a new texture to match an enhancement instruction.

In some embodiments, normal map generator 245 may be configured to generate normal maps from a structure texture. Accordingly, normal-map generators can be used to generate normal maps for any texture processed, produced, and/or generated by blockout module 240. As known to a person of ordinary skill in the art, normal maps comprise surface-normals that simulate depth when applied to objects and/or respective textures.

In some embodiments, normal map generator 245 generates normal maps that define surface depth and texture variations for enhanced structures. In some embodiments, depth estimation networks, convolutional neural networks, and multi-scale feature extraction models are used to convert texture maps into high-fidelity normal maps. In some embodiments, one or more machine learning models of normal map generator 245 are trained based at least in part on paired datasets containing RGB texture images and corresponding normal maps, allowing it to predict surface normals for any given input texture. During inference, normal map generator 245 processes structure textures and outputs a normal map that encodes fine surface variations, improving lighting and shading effects without increasing polygon count.

In some embodiments, collision mesh generator 246 may be configured to generate and/or enhance collision meshes of objects and/or assets among a virtual interactive environment to improve their surface detail and/or resolution. In some instances, a proxy mesh can be generated by collision mesh generator 246 for environmental assets that do not have an associated collision mesh. Proxy meshes can be generated by extracting surface boundaries from an initial low-resolution model and constructing a simplified polygonal representation, which may be performed through voxelization. Thereafter, the proxy mesh can be used as the collision mesh that collision mesh generator 246 enhances.

In some embodiments, collision mesh generator 246 can enhance meshes of assets through uniform mesh subdivision. As known to a person of ordinary skill in the art, the uniform mesh subdivision is a geometric processing technique used to increase the polygon count of a mesh by dividing each polygon into smaller, evenly distributed subdivisions. Accordingly, uniform mesh subdivision is a form of "mesh upscaling" for collision meshes.

Collision mesh generator 246 can also enhance meshes of structures through normal map-based vertex displacement. As known to a person of ordinary skill in the art, using normal maps to displace vertexes of polygons allows for fine surface details of the normal map to be incorporated into a collision mesh (e.g., depths and heights indicated by the normal map). In some embodiments, collision mesh generator 246 uses a combination of uniform mesh subdivision and normal map based vertex displacement to enhance a collision mesh.

Additionally, collision mesh generator 246 can also enhance meshes based at least in part on point cloud representations. As known to a person of ordinary skill in the art, video data can be used to create point cloud representations of the assets, structures and/or objects depicted in the environment. For example, collision mesh generator 246 can use gaussian splatting - a form of multi-frame spatial analysis - to generate point cloud representations of environmental assets depicted in a video. Thercafter, the point cloud representations can be used by collision mesh generator 246 to perform uniform mesh subdivision and/or vertex displacement of polygons to a collision mesh of a corresponding environmental structure represented in the video.

In some embodiments, point cloud denoising networks, three-dimensional mesh reconstruction networks, and/or Gaussian splatting inference models are used to predict and refine mesh geometry. In some embodiments, the training of one or more machine learning models of collision mesh generator 246 are based at least in part on training data including, but not limited to, three-dimensional object scans, point cloud datasets, and depth-mesh pairings. For example, point cloud data sets can be used to train models to predict missing structural details based on multi-frame input data. Likewise, paired video datasets depicting before-and-after transformations of environmental assets can enable a model to learn associations of structures change between two videos.

Collision mesh generator 246 can also include a material degradation model that is trained based at least in part on simulated degradation data sets that depict and/or represent damage and wear to materials to ensure that structural degradation (e.g., as a desired enhancement) appears natural when applicable.

During inference, collision mesh generator 246 uses Gaussian splatting to infer missing surface details, applies vertex displacement and uniform mesh subdivision to refine collision accuracy, and updates the collision mesh topology to match newly generated textures and structures.

As known to a person of ordinary skill in the art, gaussian representations and/or point cloud representations generated from video data form an implicit surface reconstruction, capturing inferred geometry details as point-based representations. In some embodiments, to apply these refinements to a collision mesh, the system converts these representations (e.g., gaussian splats) into structured 3D data using surface fitting techniques, voxelization, or implicit function reconstruction. The resulting structured mesh can then be aligned with the original collision mesh, applying uniform mesh subdivision and vertex displacement based on the inferred geometric details.

In some embodiments, after applying vertex displacement and uniform mesh subdivision, a generated and/or enhanced collision mesh can undergo geometric validation and/or optimization. The geometric validation and/or optimization process can include surface consistency checks, normal vector alignment verification, and error minimization techniques, among other things, to prevent physical inconsistencies between the updated collision mesh and the visual mesh, thereby optimizing the collision mesh for real-time physics interactions within the virtual interactive environment.

In some embodiments, video generator 247 may be configured to generate videos that depict a virtual interactive environment with enhanced or refined visual fidelity based in part on a video of the virtual interactive environment that is in a lower visual fidelity. For example, a first video of a virtual interactive environment that depicts environmental assets - which may include enhancements created and/or processed by the aforementioned submodules of blockout module 240 - can be processed by video generator 247 to create a corresponding video of higher visual fidelity, or with other visual or aesthetic changes. Accordingly, video generator 247 can generate videos of a virtual interactive environment that depict further refinements or other changes.

Accordingly, video generator 247 can generate high-fidelity virtual environment videos based on an input video depicting an initial enhancement pass. In some embodiments, video super-resolution networks, frame interpolation networks, neural radiance fields and/or other neural rendering techniques are used to upscale video frames, improve detail, and refine structural accuracy. The training data may include paired low-resolution and high-resolution gameplay footage, video sequences showing environmental transitions, and time-of-day lighting changes. During inference, video generator 247 processes an input video of the virtual interactive environment to perform one or more of the following: frame interpolation and resolution upscaling, neural radiance field-based depth reconstruction and surface deformations. The outputs of the video generator 247 is a secondary "refinement" video that serves as a reference for additional refinements of assets by other submodules of blockout module 240.

In some embodiments, the video generated by video generator 247 is based at least in part on a first video and an enhancement instruction, such that the enhancement instruction provides details or guidelines for how to improve and/or change one or more visual aspects, details, or aesthetics of the virtual interactive environment captured among the first video. For example, video generator 247 can be used to generate videos that depict enhanced or upscaled textures and/or structural changes to environmental assets. Video generator 247 can be used to generate videos that depict changes to the structures of environmental assets, including adding or removing walls, doorways, windows, pillars, stairs, and other elements of the like. Likewise, video generator 247 can be used to create videos that depict changes to the visual aesthetics of environmental structures, such as depicting an old broken building as a newly constructed modern one. Similarly, video generated by video generator 247 can also change the visual aesthetics of terrain and skyboxes, and other environmental assets, to recreate a virtual interactive environment in a way that differs from input video: such as changing the overall theme or atmosphere from "post-apocalyptic" to "cyberpunk."

In some embodiments, a video can be generated to depict a virtual interactive environment in a lower visual fidelity. For example, a video generated by video generator 247 can also change the visual aesthetics of terrain, skyboxes, and other environmental assets, to be depicted with textures of a lower resolution, with less color or detail, and/or with simplified structure details (e.g., lower polygon count). This may be, for instance, desirable when wanting to create a more simplistic gameplay atmosphere and/or for optimizing the runtime computational costs of the game (e.g., by trading off visual fidelity).

Additionally, the video data may serve as a reference or input for the generation and/or enhancement of textures and collision meshes. For example, the video data generated by video generator 247 can also be used by collision mesh generator 246 for generating point cloud representations.

In some embodiments, skybox generator 242, terrain generator 243, and/or structure texture generator 244 may be further configured to perform image analysis on the video frames 17 of videos created by 247 to generate additional enhanced and/or refined textures, such as for skyboxes, terrains, or structures. In some embodiments, the skybox generator 242, terrain generator 243, and/or structure texture generator 244 may be configured to perform procedural generation and/or material inference for the generation of textures, such as by way of one or more machine learning models.

As appreciated by one skilled in the art, each of the machine learning models of blockout module 240 - and their respective training and inference processes - may contribute in some embodiments to an integrated pipeline that enables automated, iterative, and scalable enhancement of game assets within the virtual interactive environment.

### Blockout Enhancement Process

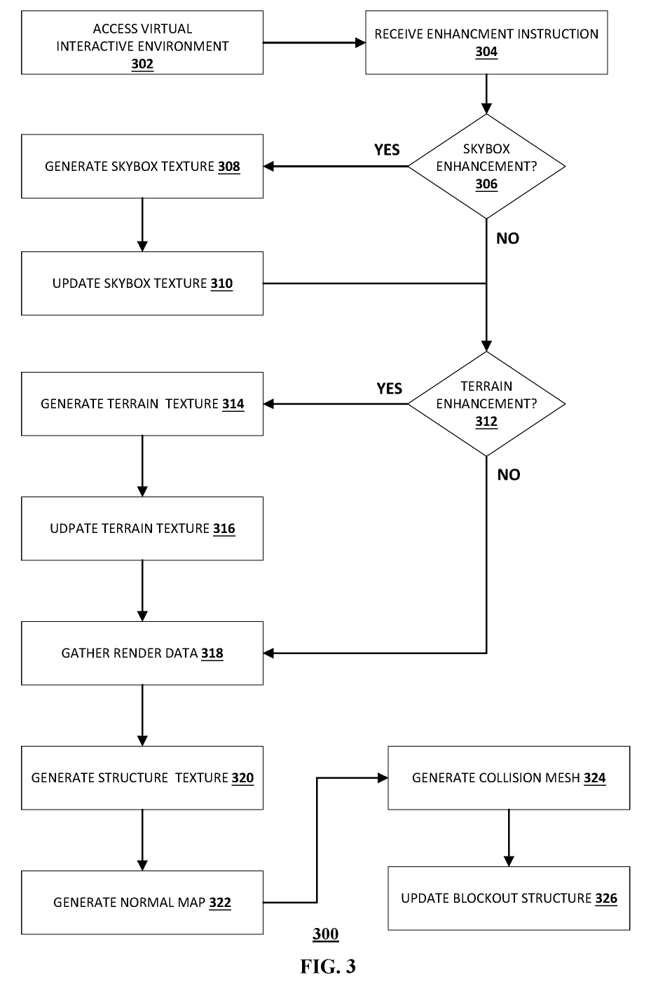

FIG. 3 illustrates a flowchart of process 300 for procedurally enhancing a virtual interactive environment using a blockout module, according to an example embodiment. Process 300 corresponds to a blockout module configured to enhance various aspects of a virtual interactive environment, including skyboxes, terrain, and blockout structures, through procedural generation techniques. In some embodiments, process 300 corresponds to blockout module 240 of FIG. 2.

At step 302, the blockout module accesses a virtual interactive environment corresponding to a video game application. The virtual interactive environment may include blockout structures, skyboxes, terrain, and other environmental elements that can be processed and/or enhanced by the blockout module. In some embodiments, a sub-module of a blockout module 240 is configured to analyze the virtual interactive environment and determine which environmental elements and/or aspects of environmental elements (e.g., textures or meshes) desire enhancement as part of step 302.

Accordingly, the analysis of step 302 may involve evaluating the visual fidelity, structural integrity, and overall aesthetic quality of the environment. In some embodiments, the analysis or evaluation is performed by a vision-based machine learning model, such as a convolutional neural network. Accordingly, one or more submodules of blockout module 240 - such as, but not limited to, input module 241 - may include a machine learning model trained to identify environmental elements and/or aspects of environmental elements that do not meet a configured threshold of visual fidelity for determining the need of a corresponding enhancement. The results of the determined elements may be used as, and/or supplement, enhancement instructions.

At step 304, the blockout module receives an enhancement instruction, which may include a text prompt, parameterized input, or predefined configuration labels, tags, or settings that define how one or more environmental assets among the virtual interactive environment should be enhanced and/or refined. In some embodiments, enhancement instructions specify modifications to textures, materials, lighting, structural properties, or environmental aesthetics.

The enhancement instructions can be processed by the blockout module using natural language processing (NLP) techniques to interpret and categorize the desired enhancements, the results of which can be used to inform the determination of steps 306 and 312. In some embodiments, the analyzed instructions are mapped to specific enhancement functions, such as procedural texture synthesis or mesh subdivision. Steps 302, 304, 306, and 312 may be performed by an input module of a blockout module, such as input module 241 of FIG. 2.

At step 306, the blockout module determines whether a skybox enhancement is desired based on the received enhancement instruction. If the enhancement instruction specifies changes to the skybox, the process proceeds to step 308. Otherwise, the process continues to step 312. This decision-making process may involve analyzing the current state of the skybox and comparing it with the desired enhancements specified in the instruction.

At step 308, the blockout module generates a skybox texture corresponding to the enhancement instruction. In some embodiments, the generated skybox texture is procedurally generated and/or synthesized using learned visual patterns.

At step 310, the blockout module updates the skybox of the virtual interactive environment with the generated skybox texture. The skybox texture generation may involve high-resolution panoramic images and advanced image synthesis techniques to create realistic sky representations.

At step 312, the blockout module determines whether terrain enhancement is desired based on the enhancement instruction. If the enhancement instruction specifies terrain modifications, the process proceeds to step 314. Otherwise, the process continues to step 318. This decision-making process may involve evaluating the current terrain features and determining the need for enhancements based on the instruction.

At step 314, the blockout module generates a terrain texture corresponding to the enhancement instruction. In some embodiments, the generated terrain texture includes multiple blended material layers, such as grass, rock, sand, or snow, to create a realistic environment. The blockout module may also apply procedural noise functions or heightmaps to generate terrain features.

At step 316, the blockout module updates the terrain of the virtual interactive environment by applying the generated terrain texture. This process may involve advanced texture blending and procedural generation techniques to create detailed and realistic terrain surfaces.

At step 318, the blockout module gathers render data corresponding to blockout structures in the virtual interactive environment. The render data includes view images and depth data of blockout structures. This data collection process may involve capturing multiple images from a virtual camera from multiple views (e.g., viewpoints or perspectives) and acquiring the corresponding depth information from graphics buffers (e.g., a rendering buffer among the game engine of the game development environment that is rendering the video game). As such, these camera view images and corresponding depth data make the render data that is used as input, among other things, to generate structure textures – such as by structure texture generator 244 of blockout module 240.

At step 320, the blockout module generates a structure texture based on the gathered render data. In some embodiments, the structure texture may be created using procedural texture generation techniques, learned texture synthesis, or inferred material representations based on surrounding game assets. This step may involve advanced texture synthesis algorithms to create detailed and contextually appropriate textures for the blockout structures.

At step 322, the blockout module generates a normal map corresponding to the structure texture. The normal map encodes surface normal variations, allowing the system to simulate surface irregularities and lighting effects without increasing polygon count. This step may involve generating high-fidelity normal maps that accurately represent surface details and enhance the visual realism of the blockout structures.

At step 324, the blockout module generates a collision mesh for the blockout structure. In some embodiments, the collision mesh is generated using uniform mesh subdivision, normal map-based vertex displacement, or voxel-based geometry reconstruction techniques. The generated collision mesh ensures that the blockout structure maintains accurate physical interactions with in-game objects. This step may involve advanced mesh processing techniques to create detailed and accurate collision meshes that enhance the physical realism of the blockout structures.

At step 326, the blockout module updates the blockout structure by applying the generated texture, normal map, and collision mesh. This step refines the blockout structure by integrating the enhanced visual and structural characteristics, improving both the realism and interactive accuracy of the virtual interactive environment. This step may involve combining multiple enhancement techniques to create a cohesive and visually appealing blockout structure.

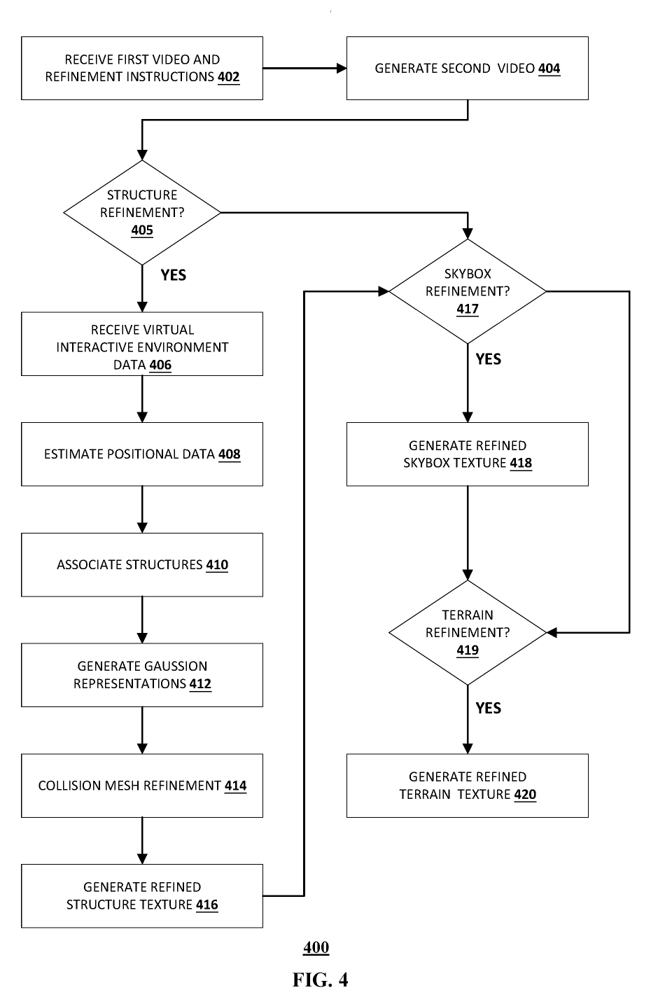

FIG. 4 illustrates a flowchart of process 400 for refining an enhanced virtual interactive environment using a blockout module, according to an example embodiment. In some embodiments, process 400 occurs after a virtual interactive environment of a video game, or environmental assets thereof, have been enhanced through process 300 of FIG. 3, or manually by a user.

Accordingly, process 400 can correspond to a “refinement of enhancements” such that it is further enhancing a virtual interactive environment and/or environmental asset that has already been enhanced (e.g., refining), such as through process 300 and/or manually by developer and/or design of a video game. As such, the terms “refine”, “refinement,” and “refining” are used distinguish subsequent enhancements from initial enhancements but may otherwise be used interchangeably with “enhance,” “enhancement,” and “enhancing”.

In some embodiments, process 400 is performed by one or more submodules of blockout module 240 of FIG. 2.

At step 402, the video generation module receives a first video of the virtual interactive environment and enhancement instructions. The first video may depict an initial enhancement pass (e.g., process 300) of a blockout structure, terrain, or skybox and serves as a reference for designing further enhancements.

In some embodiments, the enhancement instructions received are similar to the enhancement instructions described in step 304 of FIG. 3 and are processed as previously described. Accordingly, the input module (241) of blockout module (240) can be configured to analyze the enhance instruction using natural language processing (NLP) based in part on deterministic logic or machine learning models to identify and determine applicable refinements to make in process 400. In some embodiments, the analyzed instructions are mapped to specific enhancement functions, such as procedural texture synthesis or mesh subdivision.

At step 404, the blockout module processes the first video to generate a second video, which depicts an improved version of the virtual interactive environment. The second video may include higher visual fidelity, refined structural details, and improved textures. In some embodiments, the second video is generated based at least in part on one or more enhancement instructions, defining how the environment should be refined.

At step 405, the blockout module determines, based at least in part on the enhancement instructions, whether structure refinement is desired. If structure refinement is specified among the enhancement instructions, the process proceeds to step 406. Otherwise, the process continues to step 417 for skybox refinement.

At step 406, the blockout module receives data (e.g., game data) of a virtual interactive environment that corresponds to the first video. In some embodiments, the blockout module is configured to access at least positional data of camera objects, camera pathways (commonly known as camera splines), and positional data of structures associated with and/or depicted within the first video.

At step 408, the blockout module estimates positional data for refined structures based on the movement of the virtual camera object used to capture the first video. Accordingly, by receiving the positional data corresponding to the camera’s path and structures among the first video, the blockout module can identify and/or determine where the camera and structures are among the world space coordinates of the virtual interactive environment. As such, the world space coordinate data of camera and objects of the first video informs the blockout module of which structures are being refined in the second video and where they should be located within the virtual interactive environment. Because the second video depicts a refined and/or enhanced version of the virtual interactive environment, this association indicates to the blockout module which assets are to be refined based in part on the visual depictions of the second video.

In some embodiments, a blockout module estimates positional data for refined structures by analyzing frame-to-frame changes in the second video. For example, a blockout module can use structure-from-motion (SfM) algorithms, optical flow tracking, and depth estimation models, among other spatial analysis techniques of the like, to reconstruct spatial alignment between frames to inferred structure positioning in the virtual interactive environment. Accordingly, this inferred positional data is then used to associate video-based enhancements with their corresponding in-game assets.

At step 410, the blockout module uses the received game data to associate refined structures within the second video to their corresponding enhanced blockout structures of the first video. This process ensures that video-based enhancements are accurately mapped to the correct in-game assets.

At step 412, the blockout module generates Gaussian representations of the refined structures. The Gaussian representations are used to model surface detail variations, structural deformations, and inferred geometric enhancements based on the second video. In some embodiments, collision mesh generator 246 of the blockout module 240 of FIG. 2 is configured to perform step 412 by analyzing multiple frames from the second video to infer structural consistency across perspectives through Gaussian splatting (e.g., Gaussian-based reconstruction).

At step 414, the blockout module applies collision mesh refinement based on the Gaussian representations and feature details from step 412. The system may use vertex displacement, uniform mesh subdivision, or depth-based reconstruction to align the collision mesh with the inferred structure details.

When Gaussian-based refinements alter the structure of an environmental asset, the blockout module updates the collision mesh to reflect these changes, such as through collision mesh generator 246. In some embodiments, vertex positions are displaced based on the surface variations from the gaussian representation to enhance the geometry of an asset, and uniform mesh subdivision is applied to align physical boundaries with the enhanced geometry of the asset, ensuring accurate collision detection within the virtual interactive environment and/or other virtual objects, entities, or characters of the like.

At step 416, the blockout module generates a refined structure texture for the enhanced blockout structure. This refined texture is based on multi-frame analysis of the second video, ensuring that material consistency, surface detail, and texture blending are optimized for integration into the virtual interactive environment.

At step 417, the blockout module determines whether skybox refinement is desired based on the enhancement instructions. If so, the process proceeds to step 418. Otherwise, the process continues to step 419 for terrain refinement.

At step 418, the blockout module generates a refined skybox texture based on visual information extracted from the second video. In some embodiments, the refined skybox texture may include procedural or generative skybox texture synthesis, material and/or map blending, and/or texture upscaling to ensure the skybox reflects the updated lighting and atmosphere of the refined environment.

At step 419, the blockout module determines whether terrain refinement is desired. If terrain refinement is specified, the process proceeds to step 420.

At step 420, the blockout module generates a refined terrain texture. In some embodiments, this process involves terrain material blending, erosion simulation, and/or depth-based displacement mapping to ensure the terrain visually aligns with the enhanced structures and environmental elements.

The steps and processes of FIGS. 3 and 4 can be associated with one or more hardware and/or software modules configured with computer-executable instructions. For instance, one or more submodules of blockout module 240 can be configured to perform one or more steps of process 300 and/or 400. A person of ordinary skill in the art would recognize and appreciate how the proceeding process may be configured in many ways, such that one or more of the steps are performed before, after, or simultaneously among other steps, and/or otherwise omitted or substituted in whole or in part.

In some embodiments, processes 300 and 400 provide examples of enhancement workflows that can be configured to operate in parallel or sequentially. FIG. 3 describes a procedural enhancement pipeline, wherein the blockout module processes an input virtual interactive environment by applying direct texture synthesis, normal map generation, and mesh refinement techniques to improve graphical fidelity. FIG. 4 describes a video-based enhancement pipeline, where a first video is captured from an initially enhanced virtual interactive environment and used to generate a second video containing or depicting further enhancements.

Accordingly, the blockout module may execute the processes of FIGS. 3 and 4 independently or in combination. For example, a blockout structure may first undergo procedural refinement using texture generation and mesh upscaling (FIG. 3), after which a video of the enhanced asset is captured and analyzed to apply Gaussian-based reconstruction for additional fine detail improvements (FIG. 4).

In another embodiment, the blockout module may process video-based enhancements first, generating inferred refinements from a video sequence before applying procedural modifications to finalize material consistency and collision mesh accuracy. The system may dynamically determine the execution order based on available data, computational resources, or user-specified refinement parameters.

In some embodiments, the texture generation portions of process 300 and process 400 may be substituted with a queried asset from an asset library. For example, a texture for the skybox, terrain, or structure can be queried and retrieved from a texture asset library using a selection process based in part on deterministic logic and/or natural language processing, as known to those of ordinary skill in the art.

In some embodiments, game assets and/or environmental assets within a virtual interactive environment can be enhanced with different levels of visual fidelity – among processes 300 and/or 400 – based at least in part on whether they are within the playable bounds of a level or located outside the interactive space. This determination can be explicitly specified in enhancement instructions, inferred from an asset’s location within the level, or derived from tags or metadata among the asset that classify the asset as in-bounds or out-of-bounds. In some embodiments, assets within the playable space undergo higher-fidelity enhancements, such as detailed texture synthesis, fine mesh subdivision, and physically accurate material properties, to ensure they support real-time interaction, traversal, and physics-based simulations. Assets located beyond the playable bounds may receive lower-complexity enhancements to maintain visual continuity while minimizing computational costs. By dynamically adjusting the level of refinement based on asset classification and enhancement parameters, the system optimizes both performance and realism within the virtual interactive environment.

### Blockout Structure

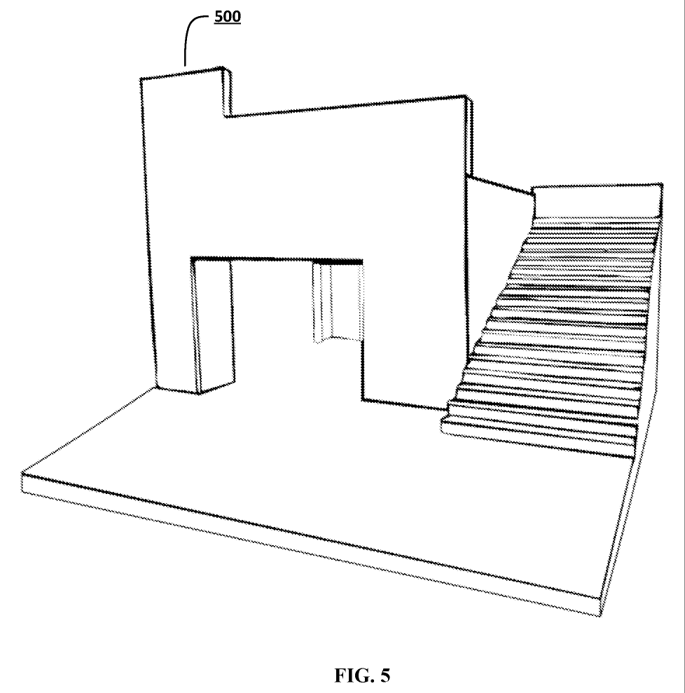

FIG. 5 illustrates an example embodiment of an environmental asset 500 within a virtual interactive environment, according to an example embodiment. Environmental asset 500 represents a blockout structure, which serves as a foundational game asset within a video game application before further refinement. In some embodiments, environmental asset 500 comprises basic geometric shapes, such as rectangular walls, a staircase, and a platform, forming the initial design of a virtual building or architectural structure.

Environmental asset 500 can be generated as part of a game development environment for level design and prototyping. The structure may be created using primitive mesh components (e.g., cubes, planes, and extrusions) to define spatial boundaries, player navigation areas, and interactive regions. In some embodiments, environmental asset 500 may be programmatically generated or manually designed.

The blockout structure can be further enhanced with various architectural styles, layouts, textures, materials, and/or surrounding terrain and integrated structures. Accordingly, in some embodiments, a blockout module (such as 240 as described in FIG. 2) may process the environmental asset 500 by applying textures, modifying mesh geometry, and generating a collision mesh to refine the structure’s visual fidelity and physical accuracy. For example, environmental asset 500 can undergo mesh subdivision and normal map-based vertex displacement to enhance surface details while optimizing computational performance.

### Enhancement Structure

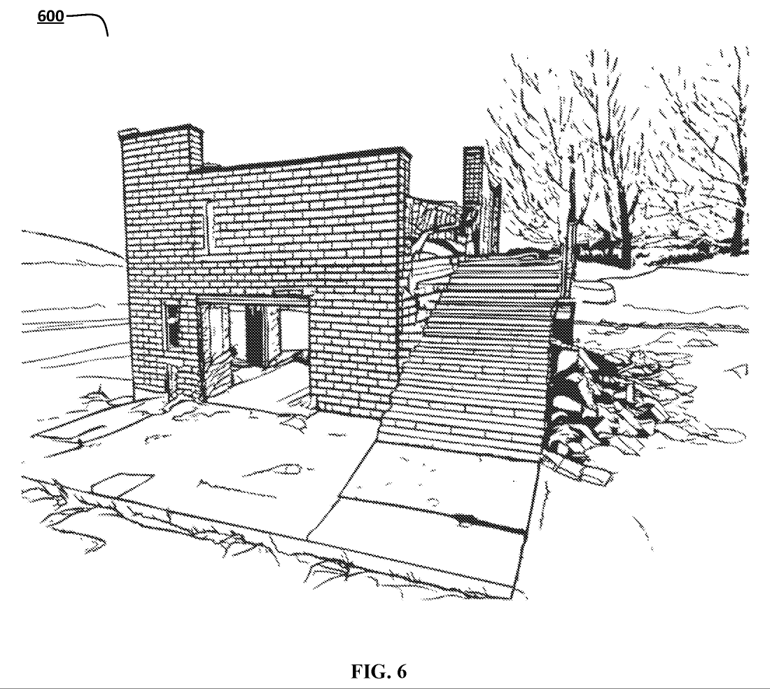

FIG. 6 illustrates an example embodiment of an enhanced environmental asset 600 within a virtual interactive environment, according to an example embodiment. Enhanced environmental asset 600 represents a refined version of environmental asset 500 (FIG. 5), where the blockout structure has undergone one or more enhancement processes to improve its visual, structural, and environmental characteristics. While the original geometric framework is retained, enhanced environmental asset 600 features new material properties, structural damage, additional surface details, and modifications to the surrounding environment, transforming it into a decayed brick building set in a desolate rural landscape.

The enhancement of enhanced environmental asset 600 may be performed through one or a combination of different refinement processes. In some embodiments, blockout module 240 applies a generation-based enhancement process, where textures, mesh modifications, and material properties are procedurally generated and applied directly to the blockout structure. This includes the synthesis of brick textures, placement of broken structural components, and terrain modifications, all of which contribute to the transformation from a basic blockout structure into a visually refined environmental asset.

In other embodiments, enhanced environmental asset 600 may be further refined based on a generated video depicting preliminary enhancements to environmental asset 500. This process involves capturing a first video of the blockout structure after an initial enhancement pass. The first video is then processed to generate a second video, which depicts the enhanced environmental asset 600 with further visual fidelity enhancements. Using the multi-frame data from the second video, Gaussian-based refinement techniques are applied to reconstruct fine surface details, structural irregularities, and object deformations, further enhancing the realism of the building’s damaged brickwork, broken windows, and surrounding rubble.

Additionally, the collision mesh associated with enhanced environmental asset 600 is updated to reflect the structural changes introduced by the enhancement processes. If Gaussian-based reconstruction is applied, vertex displacement and uniform mesh subdivision may be performed to align the collision mesh with the newly inferred structural details. Similarly, if the refinement process is based on direct procedural generation, the collision mesh is updated based on the applied textures and material definitions.

The surrounding environment of enhanced environmental asset 600 has also been refined to reflect a more immersive setting. The previously neutral background has been transformed into a desolate, post-apocalyptic landscape. Terrain modifications include procedural generation of cracked pavement, displaced debris, and erosion effects, while atmospheric rendering adjustments introduce new lighting, color grading, and environmental effects to reinforce the intended visual theme of decay and abandonment.

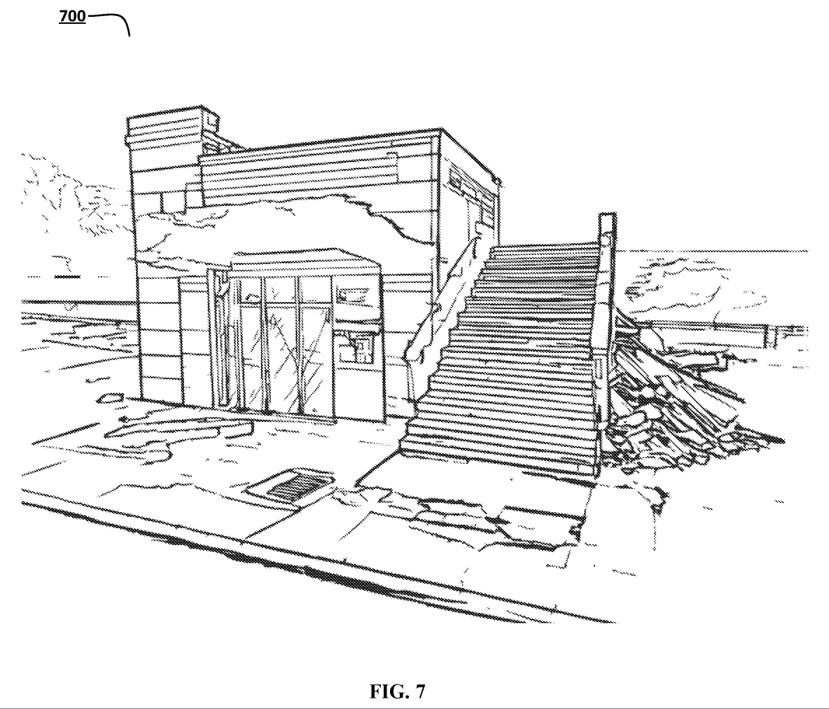

FIG. 7 illustrates an example embodiment of an enhanced environmental asset 700 within a virtual interactive environment, according to an example embodiment. Enhanced environmental asset 700 represents a refined game asset that has undergone one or more enhancement processes, transforming the original blockout structure into an abandoned commercial building with structural damage, broken windows, and debris, set within a deteriorated urban landscape.

In some embodiments, enhanced environmental asset 700 is generated from environmental asset 500 (FIG. 5) through direct procedural enhancement. In this process, a blockout module (e.g., 240) applies generation-based refinement techniques to create detailed architectural features, including textured paneling, glass storefronts, and material aging effects. This process may involve mesh subdivision, normal map-based vertex displacement, and procedural texture generation to refine structural elements and add realism. The environment surrounding asset 700 has also been updated, with procedural terrain adjustments introducing cracked pavement, collapsed structures, and scattered debris to create a desolate urban setting.

In other embodiments, enhanced environmental asset 700 is a video frame generated by video generator 247 based on enhanced environmental asset 600 (FIG. 6). A first video may be captured of enhanced environmental asset 600 after an initial enhancement pass and then processed to generate a second video depicting additional refinements to structures and terrain. Each frame of the generated video, including enhanced environmental asset 700, serves as a reference for iterative refinement, enabling blockout module 240 to extract depth information and material properties for further structural enhancements.

Using multi-frame video data, Gaussian splatting techniques may be applied to reconstruct and refine surface details, structural deformations, and environmental features. Vertex displacement and uniform mesh subdivision can be used to improve fine structural details, ensuring that the enhanced geometry aligns with inferred material degradation. Additionally, procedural texture synthesis can update surface materials, adjusting color, roughness, and damage patterns to reflect the progressive wear and tear depicted in the generated video.

The enhancements to enhanced environmental asset 700 allow for progressive refinement through multiple enhancement passes, whether directly from an initial blockout structure (e.g., environmental asset 500) or through iterative improvements based on an enhanced version (e.g., enhanced environmental asset 600) captured in video data. The combination of procedural generation, Gaussian-based refinement, and iterative texture updates enables efficient, automated asset transformation within the virtual interactive environment.

### Computing Device

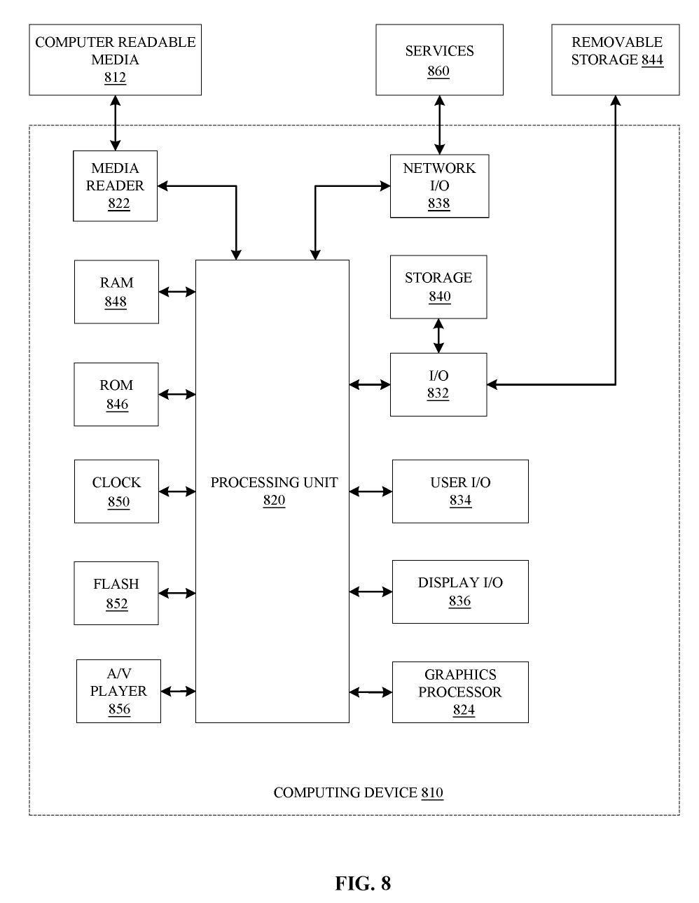

FIG. 8 illustrates an example embodiment of a computing device 810. In some embodiments, some or all of the aforementioned systems and computing device – such as computing device 110 of FIG. 1 – are similar to computing device 810. The computing device 810 can store and/or execute computer executable instructions (or code) of applications (or programs or software), such as video game applications, interactive applications, and/or other applications known to those of skill in the art that could include or benefit from the systems and methods described herein.

Computing device 810 can be or include any one or a combination of systems known to those of skill in the art, including, for example, a desktop, laptop, game application platform, game console, virtual reality system, augmented reality system, television set-top box, television, network-enabled kiosk, car-console devices, computerized appliance, wearable device (e.g., smart watch, glasses with computing functionality), and wireless mobile devices (e.g., smart phones, PDAs, tablets) and other general-purpose computing devices known to those of skill in the art.

As shown, computing device 810 includes processing unit 820 that interacts with other components of the computing device 810 and external components. A media reader 822 communicates with computer readable media 812. The media reader 822 may be an optical disc reader capable of reading optical discs, such as DVDs or Blu Ray discs, or any other type of reader that can receive and read data from computer readable media 812. One or more of the computing devices may be used to implement one or more of the systems disclosed herein.

Computing device 810 may include a graphics processor 824. In some embodiments, the graphics processor 824 may be integrated into the processing unit 820, such that the graphics processor 824 may share Random Access Memory (RAM) with the processing unit 820. Alternatively, or in addition, the graphics processor 824 may include a discrete graphics processor that is separate from the processing unit 820. In some such cases, the graphics processor 824 may have separate RAM from the processing unit 820. Computing device 810 might be a video game console device, a general-purpose laptop or desktop computer, a smart phone, a tablet, a server, or other suitable system for executing software among graphics processor 824, such as a video game application.

Computing device 810 also includes various components for enabling input/output, such as an I/O 832, a user I/O 834, a display I/O 836, and a network I/O 838. I/O 832 interacts with storage 840 and removable storage media 844 to provide storage for computing device 810. Processing unit 820 can communicate through I/O 832 to store data. In addition to storage 840 and removable storage media 844, computing device 810 is also shown including ROM (Read-Only Memory) 846 and RAM 848. RAM 848 may be used for data that is accessed frequently during execution of software.

User I/O 834 is used to send and receive commands between processing unit 820 and user devices, such as keyboards or game controllers. In some embodiments, the user I/O 834 can include a touchscreen. The touchscreen can be a capacitive touchscreen, a resistive touchscreen, or other type of touchscreen technology that is configured to receive user input through tactile inputs from the user. Display I/O 836 provides input/output functions that are used to display images. Network I/O 838 is used for input/output functions for a network (e.g., receiving and sending network data communications). Network I/O 838 may be used during execution of software applications by computing device 810; such as when a video game application communicates with a game server over a network.

Display output signals produced by processing unit 820 and/or graphics processor 824 can be sent to display by display I/O 836, including signals for displaying visual content produced by computing device 810, such as display output rendered by a video game application, including graphics, GUIs, video, and/or other visual content. Computing device 810 may comprise one or more integrated displays configured to receive display output signals produced by display I/O 836. According to some embodiments, display output signals produced by display I/O 836 may also be output to one or more display devices external to computing device 810.

The computing device 810 can also include other features, such as a clock 850, flash memory 852, and other components. An audio/video player 856 might also be used to play a video sequence, such as a movie or other media as known to those of ordinary skill in the art. An audio/video player 856 may include or use software for encoding or decoding media for playback.

Computer executable instructions, applications, programs, or code (e.g., software) can be stored in ROM 846, RAM 848, computer readable media 812, and/or storage 840 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 840, and/or on removable media such as computer readable media 812 (which can be a CD-ROM, cartridge, memory chip or the like, or obtained over a network or other electronic channel as needed). In general, applications can be found embodied in a tangible non-transitory signal-bearing medium.

Random access memory (RAM) 848 (and possibly other storage) is usable to store variables and other processor data as needed. RAM is used and holds data that is generated during the execution of an application and portions thereof might also be reserved for frame buffers, application state information, and/or other data needed or usable for interpreting user input and generating display outputs. Generally, RAM 848 is volatile storage and data stored within RAM 848 may be lost when the computing device 810 is turned off or loses power.

As computing device 810 reads computer readable media 812 and provides an application, information may be read from computer readable media 812 and stored in a memory device, such as RAM 848. Additionally, data from storage 840, ROM 846, services 860 accessed via a network (not shown), or removable storage media may be read and loaded into RAM 848. Although data is described as being found in RAM 848, it will be understood that data may not be stored in RAM 848 and may be stored in other memory accessible to processing unit 820 or distributed among several media, such as computer readable media 812 and storage 840.

The disclosed subject matter can include an apparatus for performing the operations herein. This apparatus may be specially constructed for the desired purposes, or it may comprise a general-purpose computer selectively activated or reconfigured by an application stored and/or executed by computing device 810. Such an application may be stored in a non-transitory computer readable medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The disclosed subject matter may include a non-transitory computer readable medium having stored thereon applications or instructions, which may be used (e.g., executed) to instruct a system or computing device to perform a process according to the disclosed subject matter. A non-transitory computer readable medium includes any mechanism for storing or transmitting information in a form readable by a computing device and other systems of the like known to those of skill in the art.

The applications or instructions of computing device 810 can be stored and/or executed among a local environment and/or among a distributed environment of the computing device, as known to those of skill in the art. Different applications can include varying instructions, components, graphical configurations, and/or data for supporting their runtime execution on different hardware (e.g., different types of computing devices).

A locally executed application may not rely on or use an external computing device to execute the application. In some instances, a locally executable video game application can communicate with external systems or devices, such as external servers, to retrieve information associated with the video game, such as game patches, game authentication, cloud saves, user account data, previously trained model data, or other features.

In distributed implementations, computing device 810 may execute portions of a video game application, while other systems or devices such as external servers execute other portions of the video game application. For instance, massively multiplayer online role-playing games (MMORPGs) include client portions (e.g., video game applications) of the video game executed by the computing device of or corresponding to users or players, and server portions executed by one or more servers. It should be understood that applications described herein can be a locally executable game or a distributed application.

Graphics processor 824, or a graphics processing unit (GPU), can perform processing tasks associated with rendering images, graphics, and visual content, in addition to machine learning tasks. A GPU commonly comprises multiple processing cores that execute operations in parallel, optimizing performance for tasks such as 3D rendering, texture mapping, shading, and real-time physics simulations. In addition to dedicated rasterization units, shading engines, and ray-tracing cores, a GPU may include high-bandwidth memory (VRAM) and support for general-purpose computing, enabling it to handle computational workloads beyond graphics, including scientific simulations, cryptography, and machine learning and/or neural network processing. GPUs can operate as discrete hardware components or as integrated units within system-on-chip (SoC) architectures, often interfacing with CPUs, memory controllers, and high-speed interconnects for efficient data processing.

As known to a person of ordinary skill in the art, modern GPUs increasingly incorporate dedicated machine learning hardware, such as tensor cores, matrix multiplication units, and neural processing units (NPUs), which accelerate deep learning inference, neural network training, and AI-driven rendering techniques. These specialized components enhance real-time, or near-real time, upscaling, denoising, adaptive shading, as well as neural-based image, frame, video, and audio reconstruction, among other things, allowing for more efficient and high-fidelity visual output. Accordingly, it is appreciated that GPUs can be configured to enable the execution of neural rendering models, physics-based simulations, and real-time generative AI applications, in addition to the systems and methods described herein.

The present disclosure may use machine learning. Machine learning is a subfield of artificial intelligence, which, to persons of ordinary skill of the art, corresponds to underlying algorithms and/or frameworks (commonly known as “neural networks” or “machine learning models”) that are configured and/or trained to perform and/or automate one or more tasks or computing processes. For simplicity, the terms “neural networks” and “machine learning models” can be used interchangeably and can be referred to as either “networks” or “models” in short.

The present disclosure may use deep learning. Deep learning is a subfield of artificial intelligence and machine learning, which, to persons of ordinary skill of the art, corresponds to multilayered implementations of machine learning (commonly known as “deep neural networks”). For simplicity, the terms “machine learning” and “deep learning” can be used interchangeably.

As known to a person of ordinary skill in the art, machine learning is commonly utilized for performing and/or automating one or more tasks such as identification, classification, determination, adaptation, grouping, and generation, among other things. Common types (e.g., classes or techniques) of machine learning include supervised, unsupervised, regression, classification, reinforcement, and clustering, among others.

Among these machine learning types are a number of model implementations, such as linear regression, logistic regression, evolution strategies (ES), convolutional neural networks (CNN), deconvolutional neural networks (DNN), generative adversarial networks (GAN), recurrent neural networks (RNN), mixture-of-experts (MoE), transformers, support vector machines (SVM), Bayesian networks, k-nearest neighbors (KNN), decision trees, gradient boosting machines (GBM), autoencoders, long short-term memory networks (LSTM), reinforcement learning models (RL), imitation learning models (IL), and random forest, among others. As known to a person of ordinary skill in the art, one or more machine learning models can be configured and trained for performing one or more tasks during runtime of a machine learning module.

As known to a person of ordinary skill in the art, the output of a machine learning model is based at least in part on its type, implementation, configuration, and/or training data. The data that models are trained on (e.g., training data) can include one or more data types. In some embodiments, the training data of a model can be changed, updated, and/or supplemented throughout training and/or inference (i.e., runtime) of the model.

The systems, methods, and/or computing device of the present disclosure can include machine learning modules. A “machine learning module” is a software module and/or hardware module including computer-executable instructions to configure, train, and/or deploy (e.g., execute) one or more machine learning models.

Some aspects of the present disclosure include subject matter corresponding to the gameplay of video game applications. As known to a person of ordinary skill in the art, the gameplay of a video game is commonly known as occurring among a game session within one or more instances of one or more virtual interactive environments. The gameplay of a video game provides interactivity with one or more aspects of a video game.

A game session may include a number of player characters and/or non-player characters. As known to those of skill in the art, player characters are character models that can be controlled or directed (at least primarily) by users or players through inputs at their respective computing device, and can perform gameplay actions or commands. “Non-player characters” (also referred to herein as “NPCs”) are characters that are not or cannot be controlled and/or directed (primarily by users or players). NPCs may be configured with computer executable instructions to perform one or more gameplay tasks and/or actions, with and/or without the need for input or interaction from a user/player or player character.

A game session may include a number of player objects. Player objects can refer to controllable objects, or models, used to facilitate or enable gameplay or other in-game actions. Player objects may be, for example, vehicles, vessels, aircraft, ships, tiles, cards, dice, pawns, and other in-game items of the like known to those of skill in the art. In some embodiments, a user or player can control or direct one or more player objects in a game session, including, in some instances, by controlling player characters which in turn causes the objects to be controlled.

For simplicity, player characters and player objects disclosed are collectively referred to herein as player characters in some embodiments. It should be understood that, as used herein, “controllable” refers to the characteristic of being able and/or configured to be controlled and/or directed (e.g., moved, modified, etc.) by a player or user through one or more input means, such as a controller or other input device, by a player or user. As known to a person of ordinary skill in the art, player characters include character models configured to receive input.

Some aspects of the present disclosure include subject matter corresponding to data of video game applications. As known to a person of ordinary skill in the art, data of a video game application can include data such as state data, simulation data, rendering data, digital assets, and other data of the like.

State data is commonly known as data describing a state of a player character, virtual interactive environment, and/or other virtual objects, actors, or entities – in whole or in part – at one or more instances or periods of time during a game session of a video game. For example, state data can include the current location and condition of one or more player characters among a virtual interactive environment at a given time, frame, or duration of time or number of frames.

State data can be simulated and/or generated by a simulator of a video game engine to produce simulation data. Simulation data, or state simulation data, is commonly known as the underlying data corresponding to the simulated aspects (e.g., physics and other corresponding mechanics) to drive simulation of a model or object in a game engine. For example, simulation data can include the joint and structural configuration of a character model and corresponding physical forces or characteristics applied to it at an instance or period of time during gameplay, such as a “frame,” to create animations, among other things. Accordingly, simulation data can correspond to the positioning, movements, and/or animation of objects and/or characters in a video game.

Render Data is commonly known as the underlying data corresponding to rendering (e.g., visual and auditory rendering) aspects of a game session, which are rendered (e.g., for output to an output device) by a game engine. For example, render data can include data corresponding to the rendering of graphical, visual, auditory, and/or haptic output of a video game, among other things.

Game assets (or assets in short) can include virtual objects, character models, actors, entities, geometric meshes, textures, terrain maps, animation files, audio files, digital media files, font libraries, visual effects, and other digital assets commonly used in video games of the like.

In some embodiments, a game session or gameplay is based in part on the data of a video game. One or more aspects of gameplay (e.g., rendering, simulation, state, gameplay actions of player characters) uses, produces, generates, and/or modifies game data. Likewise, gameplay events, objectives, triggers, and other aspects, objects, or elements of the like also use, produce, generate, and/or modify data of a video game.

The data of a video game may be updated, versioned, and/or stored periodically as a number of files to a computing device. Additionally, game data, or copies and/or portions thereof, can be stored, referenced, categorized, or placed into a number of buffers or storage buffers. A buffer can be configured to capture particular data, or data types, of game data for processing and/or storage.

Some aspects of the present disclosure include subject matter corresponding to video games, including video game components corresponding to the software of a video game. As known to a person of ordinary skill in the art, game code is software defining the gameplay, features, and aspects of a video game whereas a game engine provides underlying frameworks and software that support and facilitate execution of the game code (e.g., gameplay)

As a non-limiting descriptive example, a game engine includes, among other things, a renderer, simulator, and stream layer. A game engine uses game data (e.g., state data, render data, simulation data, audio data, and other data types of the like) to generate and/or render one or more outputs (e.g., visual output, audio output, and haptic output) for one or more computing devices. In some embodiments, a game engine is a distributable computer executable runtime portion of development software, such as a video game development engine.

A renderer is a graphics framework that manages the production of graphics corresponding to lighting, shadows, textures, user interfaces, and other effects to game assets of the like among a game engine. A simulator refers to a framework that manages simulation aspects corresponding to physics and other corresponding mechanics used in part for animations and/or interactions of gameplay objects, entities, characters, lighting, gasses, and other game assets or effects of the like. A stream layer is a software layer that allows a renderer and simulator to execute independently of one another among a game engine by providing a common execution stream for renderings and simulations to be produced and/or synchronized (e.g., scheduled) at and/or during runtime.

A game engine also includes an audio engine or audio renderer that produces and synchronizes audio playback with or among the common execution of a stream layer. For example, an audio engine of a game engine can use game data to produce audio output and/or haptic output from game data.

As used herein in some embodiments, video game applications can also use and/or include Software Development Kits (SDKs), Application Program Interfaces (APIs), Dynamically Linked Libraries (DLLs), and other software libraries, components, modules, shims, or plugins that provide and/or enable a variety of functionality; such as – but not limited to – graphics, audio, font, or communication support, establishing and maintaining service connections, performing authorizations, and providing anti-cheat and anti-fraud monitoring and detection, among other things.

Some portions of the detailed descriptions above are presented in terms of symbolic representations of operations on data bits within a computer memory. These algorithmic descriptions and representations are the means used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. These quantities may take the form of electrical or magnetic signals capable of being stored, transferred, combined, compared, and otherwise manipulated (e.g., among a computing device). It has proven convenient at times, principally for reasons of common usage, to refer to these signals as bits, values, elements, symbols, characters, terms, numbers, or the like.

Certain example embodiments are described above to provide an overall understanding of the principles of the structure, function, manufacture and use of the devices, systems, and methods described herein. One or more examples of these embodiments are illustrated in the accompanying drawings. Those skilled in the art will understand that the descriptions herein and the accompanying drawings are intended to be illustrative, and not restrictive. Many other implementations will be apparent to those of skill in the art based upon the above description. Such modifications and variations are intended to be included within the scope of the present disclosure. The scope of the present disclosure should, therefore, be considered with reference to the claims, along with the full scope of equivalents to which such claims are entitled. The features illustrated or described in connection with one embodiment may be combined with the features of other embodiments. In some instances, well-known structures and devices are shown in block diagram form to avoid obscuring the disclosed subject matter.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user’s privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A system comprising:
one or more processors; and
one or more memory devices communicatively coupled to the one or more processors, the one or more memory devices storing computer-executable instructions that, during runtime execution by the one or more processors, causes at least one of the one or more processors to:
access a virtual interactive environment; and
enhance graphical fidelity properties of environmental assets among the virtual interactive environment, the environmental assets including at least a skybox, a terrain, and a blockout structure, wherein:
(a) enhancement of the graphical fidelity properties of the skybox comprises at least applying a skybox texture to the skybox, and wherein the skybox texture is generated based at least in part on a first enhancement instruction that defines a visual aesthetic for the skybox;
(b) enhancement of the graphical fidelity properties of the terrain comprises at least applying a terrain texture to the terrain, and wherein the terrain texture is generated based on a second enhancement instruction that defines a visual aesthetic for the terrain; and
(c) enhancement of the graphical fidelity properties of the blockout structure of the virtual interactive environment comprises:
(i) gathering render data corresponding to the blockout structure, the render data comprising at least a plurality of view images associated with the blockout structure and depth data corresponding to each view image among the plurality;
(ii) generating a structure texture based on the gathered render data and a third enhancement instruction that defines a visual aesthetic for the blockout structure;
(iii) generating a normal map comprising surface normals based on the structure texture;
(iv) generating a collision mesh based on the normal map and the blockout structure; and,
(v) applying the structure texture, normal map, and collision mesh to the blockout structure to create an enhanced blockout structure.

2. The system of claim 1, wherein the generated collision mesh applied to the blockout structure replaces a first collision mesh of the blockout structure, the first collision mesh being based on at least one of (i) a shape of the blockout structure, or (ii) a voxelized representation of the blockout structure.

3. The system of claim 2, wherein generating the collision mesh is based on a uniform mesh subdivision of the first collision mesh, the uniform mesh subdivision increasing an amount of polygon faces of the first collision mesh to generate the collision mesh.

4. The system of claim 3, wherein generating the collision mesh further comprises adjusting vertex positions of the polygon faces in the generated collision mesh, wherein adjusting vertex positions is based on surface details of the structure texture represented in the normal map.

5. The system of claim 1, wherein after enhancing the virtual interactive environment, the system is further configured to:
capture a first video of the virtual interactive environment using a virtual camera, and
generate a second video that refines a visual fidelity of the first video based on a fourth enhancement instruction that defines one or more image enhancement properties, wherein the second video includes a plurality of refined structures, wherein each refined structure in the plurality of refined structures is an image-based enhancement of a corresponding enhanced blockout structure captured among the first video.

6. The system of claim 5, wherein the system is further configured to:
receive at least:
(i) a virtual camera path associated with the virtual camera comprising a set of positional points the virtual camera used to move through the virtual interactive environment to capture the first video, and
(ii) positional points of each corresponding enhanced blockout structure captured among the first video;
estimate positional points of each refined structure included in the second video, based on positional points of the virtual camera path and the positional points of each corresponding enhanced blockout structure;
associate each of the refined structures to each corresponding enhanced blockout structure, wherein the association is based on the estimated positional points of the plurality of refined structures and the positional points of each corresponding enhanced blockout structure; and
refine each corresponding enhanced blockout structure , by:
generating a gaussian representation of each refined structure based on one or more frames of the second video; and
performing vertex displacement and uniform mesh subdivision to the collision mesh of each corresponding enhanced blockout structure based on the gaussian representation.

7. The system of claim 6, wherein the system is further configured to generate, based on the second video, a refinement texture for one or more of the environmental assets.

8. A method to improve a video game by:
accessing a virtual interactive environment; and
enhancing graphical fidelity properties of environmental assets among the virtual interactive environment, the environmental assets including at least a skybox, a terrain, and a blockout structure, wherein:
(a) the enhancement of the graphical fidelity properties of the skybox comprises at least applying a skybox texture to the skybox, and wherein the skybox texture is generated based at least in part on a first enhancement instruction that defines a visual aesthetic for the skybox;
(b) the enhancement of the graphical fidelity properties of the terrain comprises at least applying a terrain texture to the terrain, and wherein the terrain texture is generated based on a second enhancement instruction that defines a visual aesthetic for the terrain; and
(c) the enhancement of the graphical fidelity properties of the blockout structure of the virtual interactive environment comprises:
(i) gathering render data corresponding to the blockout structure, the render data comprising at least a plurality of view images associated with the blockout structure and depth data corresponding to each view image among the plurality;
(ii) generating a structure texture based on the gathered render data and a third enhancement instruction that defines a visual aesthetic for the blockout structure;
(iii) generating a normal map comprising surface normals based on the structure texture;
(iv) generating a collision mesh based on the normal map and the blockout structure; and,
(v) applying the structure texture, normal map, and collision mesh to the blockout structure to create an enhanced blockout structure.

9. The method of claim 8, wherein the generated collision mesh applied to the blockout structure replaces a first collision mesh of the blockout structure, the first collision mesh being based on at least one of (i) a shape of the blockout structure, or (ii) a voxelized representation of the blockout structure.

10. The method of claim 9, wherein generating the collision mesh is based on a uniform mesh subdivision of the first collision mesh, the uniform mesh subdivision increasing an amount of polygon faces of the first collision mesh to generate the collision mesh.

11. The method of claim 10, wherein generating the collision mesh further comprises adjusting vertex positions of the polygon faces in the generated collision mesh, wherein adjusting vertex positions is based on surface details of the structure texture represented in the normal map.

12. The method of claim 8, wherein after enhancing the virtual interactive environment, the method further comprises:
capturing a first video of the virtual interactive environment using a virtual camera; and
generating a second video that refines a visual fidelity of the first video based on a fourth enhancement instruction that defines one or more image enhancement properties, wherein the second video includes a plurality of refined structures, wherein each refined structure in the plurality of refined structures is an image-based enhancement of a corresponding enhanced blockout structure captured among the first video.

13. The method of claim 12, wherein the method further comprises:
receiving at least:
(i) a virtual camera path associated with the virtual camera comprising a set of positional points the virtual camera used to move through the virtual interactive environment to capture the first video, and
(ii) positional points of each corresponding enhanced blockout structure captured among the first video;
estimating positional points of each refined structure included in the second video, based on positional points of the virtual camera path and the positional points of each corresponding enhanced blockout structure;
associating each of the refined structures to each of corresponding enhanced blockout structures, wherein the association is based on the estimated positional points of the plurality of refined structures and the positional points of each corresponding enhanced blockout structure; and
refining each corresponding enhanced blockout structure by:
generating a gaussian representation of each refined structure based on one or more frames of the second video, and
performing vertex displacement and uniform mesh subdivision to the collision mesh of each corresponding enhanced blockout structure based on the gaussian representation.

14. The method of claim 13, wherein the method further comprises generating, based on the second video, a refinement texture for one or more of the environmental assets.

15. A non-transitory computer readable medium storing computer-executable instructions to improve a video game by:
accessing a virtual interactive environment; and
enhancing graphical fidelity properties of environmental assets among the virtual interactive environment, the environmental assets including at least a skybox, a terrain, and a blockout structure, wherein:
(a) the enhancement of the graphical fidelity properties of the skybox comprises at least applying a skybox texture to the skybox, and wherein the skybox texture is generated based at least in part on a first enhancement instruction that defines a visual aesthetic for the skybox;
(b) the enhancement of the graphical fidelity properties of the terrain comprises at least applying a terrain texture to the terrain, and wherein the terrain texture is generated based on a second enhancement instruction that defines a visual aesthetic for the terrain; and
(c) the enhancement of the graphical fidelity properties of the blockout structure of the virtual interactive environment comprises:
(i) gathering render data corresponding to the blockout structure, the render data comprising at least a plurality of view images associated with the blockout structure and depth data corresponding to each view image among the plurality;
(ii) generating a structure texture based on the gathered render data and a third enhancement instruction that defines a visual aesthetic for the blockout structure;
(iii) generating a normal map comprising surface normals based on the structure texture;
(iv) generating a collision mesh based on the normal map and the blockout structure; and
(v) applying the structure texture, normal map, and collision mesh to the blockout structure to create an enhanced blockout structure.

16. The non-transitory computer readable medium of claim 15, wherein the generated collision mesh applied to the blockout structure replaces a first collision mesh of the blockout structure, the first collision mesh being based on at least one of (i) a shape of the blockout structure, or (ii) a voxelized representation of the blockout structure.

17. The non-transitory computer readable medium of claim 16, wherein generating the collision mesh further comprises adjusting vertex positions of polygon faces in the generated collision mesh, wherein adjusting vertex positions is based on surface details of the structure texture represented in the normal map.

18. The computer readable medium of claim 15, wherein after enhancing the virtual interactive environment, further comprises:
capturing a first video of the virtual interactive environment using a virtual camera; and
generating a second video that refines a visual fidelity of the first video based on a fourth enhancement instruction that defines one or more image enhancement properties, wherein the second video includes a plurality of refined structures, wherein each refined structure in the plurality of refined structures is an image-based enhancement of a corresponding enhanced blockout structure captured among the first video.

19. The computer readable medium of claim 18 further comprising:
receiving at least:
(i) a virtual camera path associated with the virtual camera comprising a set of positional points the virtual camera used to move through the virtual interactive environment to capture the first video, and
(ii) positional points of each corresponding enhanced blockout structure captured among the first video;
estimating positional points of each refined structure included in the second video, based on positional points of the virtual camera path and the positional points of each corresponding enhanced blockout structure;
associating each of the refined structures to each corresponding enhanced blockout structure, wherein the association is based on the estimated positional points of the plurality of refined structures and the positional points of each corresponding enhanced blockout structure; and
refining each corresponding enhanced blockout structure by:
generating a gaussian representation of each refined structure based on one or more frames of the second video; and
performing vertex displacement and uniform mesh subdivision to the collision mesh of each corresponding enhanced blockout structure based on the gaussian representation.
